(19) United States
(12) Patent Application Publication
(10) Pub. No.: US 2010/0326114 A1
(43) Pub. Date: Dec. 30, 2010

(54) Refrigerator and water purification device

(75) Inventors: Jee Yong Kim, Seoul (KR); Sang Hoon Lee, Yeoju-gun (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/662,195

(22) Filed: Apr. 5, 2010

(30) Foreign Application Priority Data
Jun. 30, 2009 (KR) 10-2009-59125

(51) Int. Cl. F25D 27/00; C02F 1/32; F25D 3/00; F25D 23/02

(52) U.S. Cl. 62/264; 210/199; 210/139; 210/109; 62/389; 62/449

(57) ABSTRACT

Disclosed herein is a refrigerator. The refrigerator includes a refrigerator body having at least one storage chamber, a door to open and close the storage chamber, a water dispenser provided in the door, and a water purification unit to purify water to be supplied to the water dispenser. The water purification unit includes a housing having an inlet port and an outlet port, a transparent tube provided in the housing, a germicidal lamp provided in the transparent tube to emit ultraviolet rays, and a flow channel defining member provided between the housing and the transparent tube. The flow channel defining member includes a plurality of partitions perpendicular to an outer circumference of the transparent tube. Each of the partitions has at least one communication hole.

### CROSS-REFERENCE TO RELATED APPLICATIONS

This application claims the benefit of Korean Patent Application No. 2009-0059125, filed on Jun. 30, 2009 in the Korean Intellectual Property Office, the disclosure of which is incorporated herein by reference.

### BACKGROUND

1. Field

Embodiments relate to a refrigerator and a water purification device including a water purification unit.

2. Description of the Related Art

Generally, a refrigerator is an apparatus to store food at low temperature. The refrigerator includes a freezing chamber to store food at a relatively low temperature and a second storage chamber to store food at a higher temperature than the freezing chamber.

In recent years, refrigerators including various additional functions have been developed and produced according to consumer demand. One of the additional functions is a water dispensing function to dispense purified water. Water may be purified by filters or ultraviolet rays.

Ultraviolet water purification removes harmful microorganisms, such as colon bacilli, viruses, bacteria, dysentery bacilli, typhoid bacilli, cholera bacilli, tubercle bacilli, pseudomonas aeruginosa, and tetanus bacilli, from water using ultraviolet rays. FIGS. 1A and 1B illustrate conventional ultraviolet water purification units.

Referring to FIG. 1A, a conventional ultraviolet water purification unit 1 includes a housing 2 having an inlet port 2a and an outlet port 2b, a quartz tube 3 provided in the housing 2, a germicidal lamp 4 provided in the quartz tube 3 to emit ultraviolet rays, and a spiral vane 5 surrounding the quartz tube 3. Water, introduced into the housing 2 through the inlet port 2a, is disinfected by ultraviolet rays emitted from the germicidal lamp 4, and is then discharged out of the housing 2 through the outlet port 2b. At this time, the water, introduced into the housing 2, flows along the spiral vane 5, with the result that dwell time of water in the housing 2 is increased. Therefore, time to expose water to ultraviolet rays is increased, thereby improving germicidal efficiency. Reference symbol t indicates a tab coupled to the outlet port 2b.

Referring to FIG. 1B, another conventional ultraviolet water purification unit 6 includes a spiral tube 8 to increase dwell time of water in a housing 7.

In the conventional ultraviolet water purification units, however, flow resistance may greatly increase. When the flow resistance increases, an additional pump may be used, or output of the pump may be increased, to smoothly take water out, with the result that energy loss may occur. Increased flow resistance may increase noise and vibration. Flow resistance may excessively increase in the ultraviolet water purification unit using the spiral tube shown in FIG. 1B.

Also, the conventional ultraviolet water purification units may be easily manufactured. Specifically, the spiral vane 5 of the ultraviolet water purification unit shown in FIG. 1A is continuously wound around a space in which the quartz tube 3 is disposed. The spiral vane may not be manufactured by injection molding, with the result that the spiral vane may not be mass-produced. When a metal sheet is deformed to manufacture the spiral vane, manufacturing costs may be increased, and a manufacturing process may be complicated. That is, productivity is very low. Furthermore, no watertight coupling between the spiral vane and the quartz tube or between the spiral vane and the housing may be achieved since the spiral vane extends in one direction in a coil. In this case, some water may not flow along the spiral vane.

The spiral tube 8 of the ultraviolet water purification unit 6 shown in FIG. 1B may not be manufactured by injection molding. The spiral tube may be manufactured by winding elastic transparent resin in a coil; however, the resin may be decolorized by ultraviolet rays or may not transmit ultraviolet rays. The spiral tube may be formed of glass. In this case, however, manufacturing costs may be excessively increased.

### SUMMARY

Therefore, it is an aspect to provide a refrigerator and a water purification device including a water purification unit of reduced flow resistance and improved productivity.

It is another aspect to provide a refrigerator and a water purification device including a water purification unit of improved germicidal efficiency.

Additional aspects will be set forth in part in the description which follows and, in part, will be apparent from the description, or may be learned by practice of the invention.

The foregoing and/or other aspects are achieved by providing a refrigerator including a refrigerator body having at least one storage chamber, a door to open and close the storage chamber, a water dispenser provided in the door, and a water purification unit to purify water to be supplied to the water dispenser, the water purification unit includes a housing having an inlet port and an outlet port, a transparent tube provided in the housing, a germicidal lamp provided in the transparent tube to emit ultraviolet rays, and a flow channel defining member provided between the housing and the transparent tube, and the flow channel defining member includes a plurality of partitions perpendicular to an outer circumference of the transparent tube, each of the partitions having at least one communication hole.

The partitions may be arranged such that communication holes of neighboring ones of the partitions deviate from each other. The communication holes of the neighboring partitions may be diagonally opposite to each other about the transparent tube. The flow channel defining member may be coupled to the outer circumference of the transparent tube and an inner circumference of the housing in a watertight state. The water purification unit may be provided in the door.

The water purification unit may be provided between an inner liner and an outer liner of the door.

The water purification unit may further include a tab coupled to the outlet port of the housing to allow water having passed through the housing to pass therethrough, and atmospheric pressure may be applied to the water passing through the tab.

The tab may include a first hole to allow water having passed through the housing to be introduced into the tab therethrough, a second hole to allow the water introduced through the first hole to be discharged out of the tab therethrough, a through-channel connected between the first hole and the second hole, and a third hole to allow atmospheric pressure to be applied to the through-channel therethrough.

The third hole may include a plurality of third holes arranged radially about the first hole.

The water purification unit may further include a tab coupled to the outlet port of the housing, the tab having a through-channel to allow water having passed through the housing to pass therethrough, and the tab may include an isolator provided at the through-channel to prevent the ultraviolet rays emitted from the germicidal lamp from being discharged outside through the through-channel.

The isolator may include at least one wall. The isolator may include a body to intercept ultraviolet rays and a support to support the body at an inner circumference of the through-channel. The body of the isolator may have a greater sectional area than an outlet port of the through-channel.

The ultraviolet rays emitted from the germicidal lamp may have an intensity rising for a predetermined period of time after the start of the operation of the germicidal lamp, lowering to a predetermined value after the predetermined period of time, and being maintained at the predetermined value.

The germicidal lamp may be periodically operated when the flow of water through the water purification unit is stopped for a predetermined period of time.

The water dispenser may include a proximity sensor to sense movement of an object to the water dispenser, and the germicidal lamp of the water purification unit may start to operate when the movement of the object to the water dispenser is sensed by the proximity sensor.

The foregoing and/or other aspects are achieved by providing a water purification device including a water purification unit, the water purification unit includes a housing having an inlet port and an outlet port, a transparent tube provided in the housing, a germicidal lamp provided in the transparent tube to emit ultraviolet rays, and a plurality of water purification chambers provided successively in a longitudinal direction of the transparent tube while surrounding the transparent tube, and the water purification unit further includes a plurality of communication holes provided in the longitudinal direction of the transparent tube to achieve communication between neighboring ones of the water purification chambers, whereby water, introduced into the housing through the inlet port, sequentially passes through the successive water purification chambers, and is discharged out of the housing through the outlet port.

The communication holes may be provided such that an extension line linking neighboring ones of the communication holes is at an angle relative to a longitudinal extension line of the transparent tube.

The foregoing and/or other aspects are achieved by providing a refrigerator including a refrigerator body having at least one storage chamber, a door to open and close the storage chamber, a water dispenser provided in the door, and a water purification unit to purify water to be supplied to the water dispenser, the water purification unit including a housing having an inlet port and an outlet port, a water purification member provided in the housing, and a tab coupled to the outlet port of the housing to allow water having passed through the housing to pass therethrough, and atmospheric pressure is applied to the water passing through the tab such that the water is easily taken out through the tab.

The tab may include a first hole to allow water having passed through the housing to be introduced into the tab therethrough, a second hole to allow the water introduced through the first hole to be discharged out of the tab therethrough, a through-channel connected between the first hole and the second hole, and a third hole to allow atmospheric pressure to be applied to the through-channel therethrough.

The third hole may include a plurality of third holes arranged radially about the first hole.

The water purification member may include a germicidal lamp to emit ultraviolet rays.

The foregoing and/or other aspects are achieved by providing a refrigerator including a refrigerator body having at least one storage chamber, a door to open and close the storage chamber, a water dispenser provided in the door, and a water purification unit to purify water to be supplied to the water dispenser, the water purification unit includes a housing having an inlet port and an outlet port, a germicidal lamp provided in the housing to emit ultraviolet rays to water passing through the housing, and a tab coupled to the outlet port of the housing to allow the water having passed through the housing to pass therethrough, and the tab includes a through-channel to allow water to pass therethrough and an isolator provided at the through-channel to prevent the ultraviolet rays emitted from the germicidal lamp from being discharged outside through the through-channel.

The isolator may include at least one wall.

The isolator may include a body to intercept ultraviolet rays and a support to support the body at an inner circumference of the through-channel.

The body of the isolator may have a greater sectional area than an outlet port of the through-channel.

### BRIEF DESCRIPTION OF THE DRAWINGS

These and/or other aspects will become apparent and more readily appreciated from the following description of the embodiments, taken in conjunction with the accompanying drawings of which:

FIGS. 1A and 1B are views illustrating conventional ultraviolet water purification units;

FIG. 2 is a sectional view illustrating a refrigerator according to an embodiment;

FIG. 3 is a perspective view illustrating a water purification unit according to an embodiment;

FIG. 4 is an exploded perspective view of the water purification unit of FIG. 3;

FIG. 5 is a perspective view illustrating a tab according to an embodiment;

FIG. 6 is a sectional view taken along line A-A of FIG. 5;

FIGS. 7A and 7B are views illustrating the operation of the water purification unit of FIG. 3;

FIG. 8 is a graph illustrating time-based intensity change of ultraviolet rays emitted from a germicidal lamp according to an embodiment;

FIG. 9 is a flow chart illustrating the operation of a water purification unit according to an embodiment in an idle state;

FIG. 10 is a perspective view, corresponding to FIG. 7, illustrating a flow channel defining member according to another embodiment; and

FIG. 11 is a partially cutaway perspective view illustrating a tab according to another embodiment.

### DETAILED DESCRIPTION

Reference will now be made in detail to the embodiments, examples of which are illustrated in the accompanying drawings, wherein like reference numerals refer to like elements throughout.

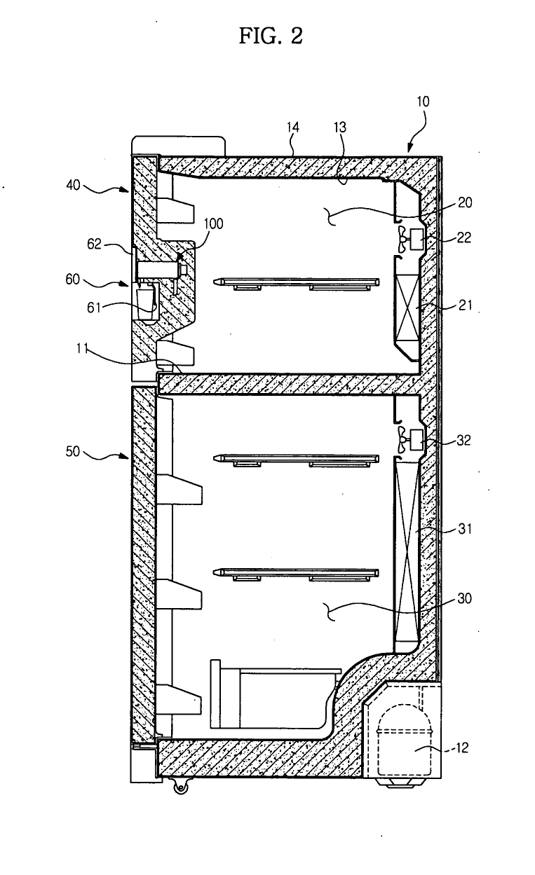

FIG. 2 is a sectional view illustrating a refrigerator according to an embodiment.

As shown in FIG. 2, the refrigerator includes a refrigerator body 10 having a first storage chamber 20 and a second storage chamber 30 partitioned by an intermediate partition 11. The refrigerator body 10 has an inner liner 13 and an outer liner 14. A foam member is placed between the inner liner 13 and the outer liner 14.

The first storage chamber 20 and the second storage chamber 30 each have an open front. The first storage chamber 20 is located above the second storage chamber 30. The first storage chamber 20 is opened and closed by a first storage chamber door 40. The second storage chamber 30 is opened and closed by a second storage chamber door 50.

At the inside rear of the first storage chamber 20 are mounted a first storage chamber evaporator 21 to cool the first storage chamber 20 and a first storage chamber circulation fan 22 to circulate cool air in the first storage chamber 20. At the inside rear of the second storage chamber 30 are mounted a second storage chamber evaporator 31 to cool the second storage chamber 30 and a second storage chamber circulation fan 32 to circulate cool air in the second storage chamber 30. Reference numeral 12 indicates a compressor to compress a refrigerant to be supplied to the first storage chamber evaporator 21 and the second storage chamber evaporator 31.

The first storage chamber door 40 and the second storage chamber door 50 are hingedly coupled to the refrigerator body 10 to open and close the first storage chamber 20 and the second storage chamber 30, respectively. The structure and arrangement of the first storage chamber, the second storage chamber, and the doors to open and close the respective storage chambers in this embodiment are illustrative and may be modified in various ways. For example, the refrigerator body may have three or more storage chambers, or temperatures of the respective storage chambers may be adjusted according to user convenience.

Also, the refrigerator further includes a water dispenser 60 and a water purification unit 100 to purify water to be supplied to the water dispenser 60.

The water dispenser 60 is provided in the first storage chamber door 40 such that a user may take out purified water or carbonated water through the water dispenser 60 without opening the first storage chamber door 40. When the user pushes a container such as a cup against a lever 61, water may be taken out through the water dispenser 60.

The water purification unit 100 is provided between the inner liner 13 and the outer liner 14 to remove various germs from water. The water purification unit 100 may be directly mounted to the inner liner 13 or the outer liner 14. Alternatively, the water purification unit 100 may be mounted at one side of the refrigerator body 10.

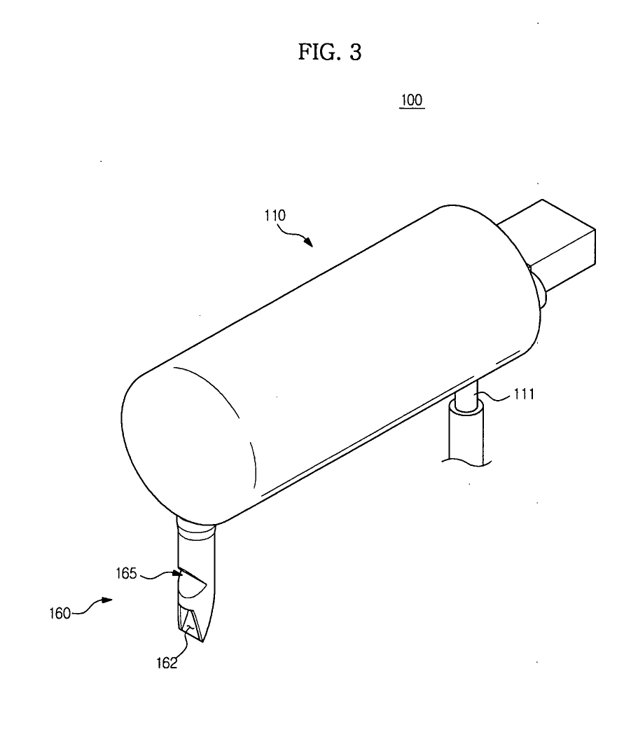

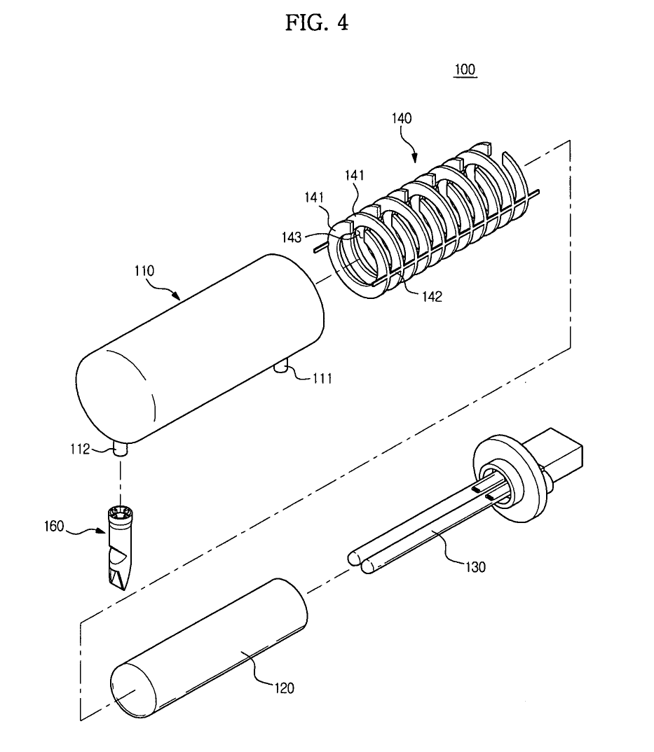

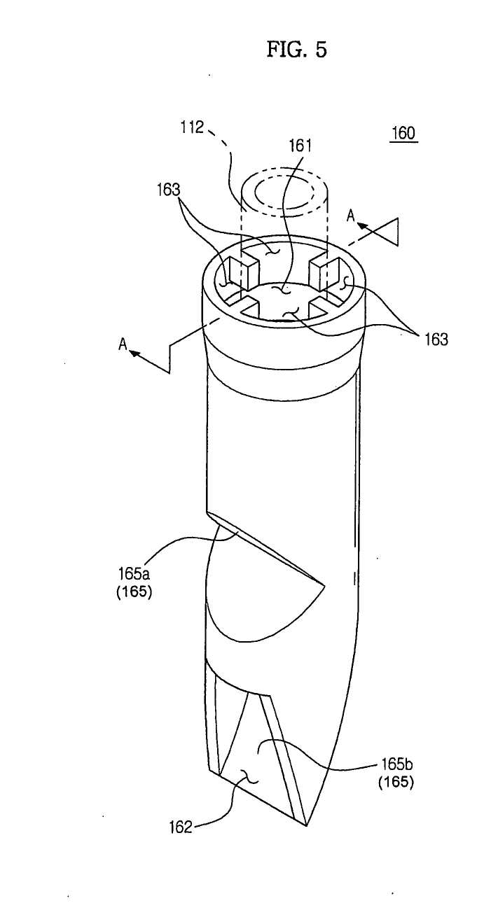

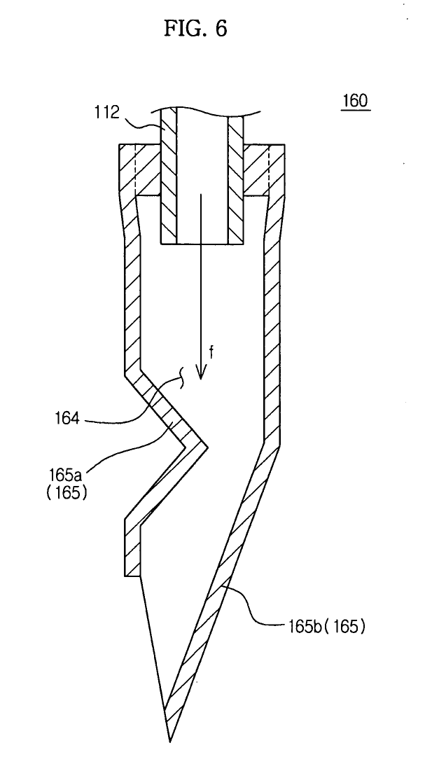

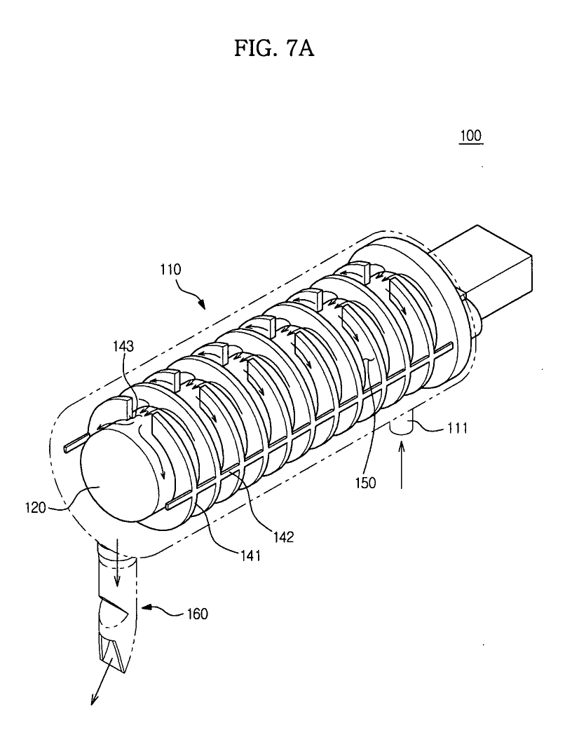

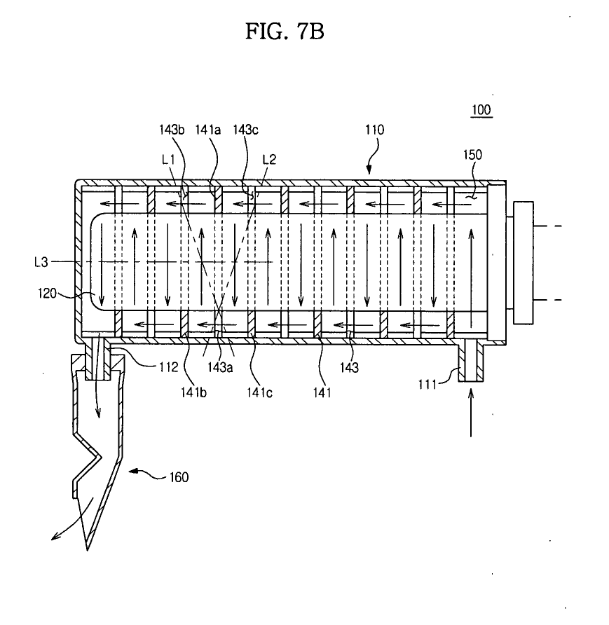

FIG. 3 is a perspective view illustrating a water purification unit according to an embodiment, FIG. 4 is an exploded perspective view of the water purification unit of FIG. 3, FIG. 5 is a perspective view illustrating a tab according to an embodiment, FIG. 6 is a sectional view taken along line A-A of FIG. 5, and FIGS. 7A and 7B are views illustrating the operation of the water purification unit of FIG. 3.

As shown in FIGS. 3 and 4, the water purification unit 100 includes a housing 110, a transparent tube 120, a germicidal lamp 130, and a flow channel defining member 140.

The housing 110 is provided at one side thereof with an inlet port 111 through which water is introduced into the housing 110 and at the other side thereof with an outlet port 112 through which water is discharged out of the housing 110. The housing 110 may be formed by injection-molding a resin material. Alternatively, the housing 110 may be formed of metal, such as aluminum, or ceramics.

The transparent tube 120 is disposed in the housing 110. The germicidal lamp 130 is disposed in the transparent tube 120 to emit ultraviolet rays. The transparent tube 120 is formed of a transparent material to transmit the ultraviolet rays emitted from the germicidal lamp 130. For example, the transparent tube 120 may be formed of quartz or transparent resin.

As described above, the germicidal lamp 130 is disposed in the transparent tube 120 to emit ultraviolet rays to water passing between the transparent tube 120 and the housing 110. Ultraviolet rays may have a wavelength of between 210 nm and 329 nm. Germicidal light emitted from the germicidal lamp 130 is not limited to Ultraviolet rays. For example, the germicidal light may include plasma or other kinds of light having a germicidal function.

The flow channel defining member 140 is disposed between the housing 110 and the transparent tube 120 to increase dwell time of water introduced into the housing 110 such that the water is exposed to ultraviolet rays for an increased period of time. The increase of time during which water is exposed to ultraviolet rays increases germicidal efficiency of the ultraviolet rays.

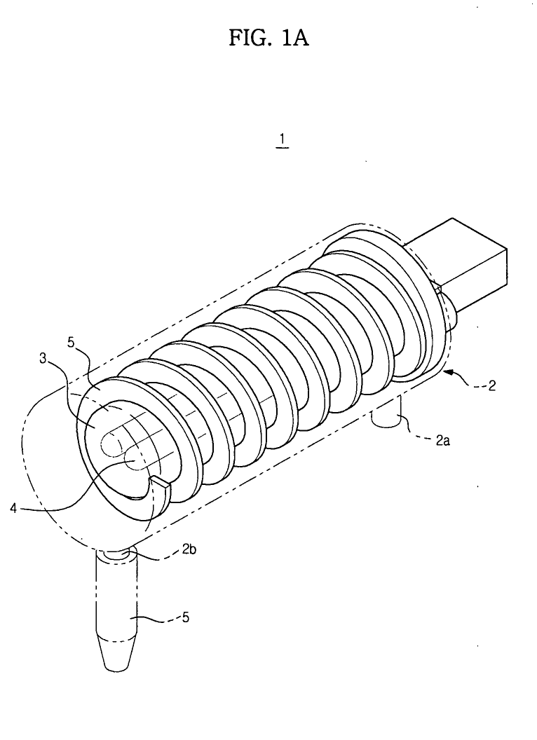

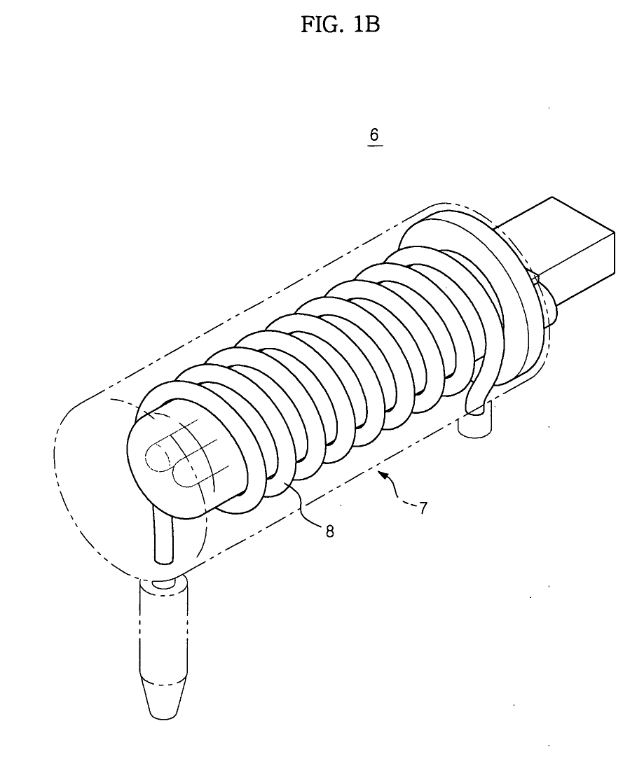

The flow channel defining member 140 includes a plurality of partitions 141 and a frame 142 to interconnect and support the partitions 141. The partitions 141 are arranged in the longitudinal direction of the transparent tube 120 such that the partitions 141 are perpendicular to the outer circumference of the transparent tube 120. Each of the partitions 141 has a communication hole 143. Since the partitions 141 are perpendicular to the outer circumference of the transparent tube 120, there is no dead zone where ultraviolet rays are intercepted by the partitions 141 (the conventional germicidal unit shown in FIG. 1A has a dead zone where ultraviolet rays are intercepted by the spiral vane 5). Also, the partitions 141 are parallel to one another, with the result that the flow channel defining member 140 is easily injection-molded and separated from a mold. Therefore, mass production through injection molding is achieved. The partitions 141 may be produced while the partitions 141 are connected to one another via the frame 142. Alternatively, the partitions 141 may be produced without the frame 142 and then mounted to the outer circumference of the transparent tube 120 or the inner circumference of the housing 110. Also, the partitions 141 may be integrally formed with the transparent tube 120 or the housing 110.

A plurality of water purification chambers 150 (See FIGS. 7A and 7B) provided successively in the longitudinal direction of the transparent tube 120 are defined by the partitions 141, the outer circumference of the transparent tube 120, and the inner circumference of the housing 110. Each of the water purification chambers 150 is formed in the shape of a ring to surround the transparent tube 120. Water in each of the water purification chambers 150 flows to the next water purification chamber 150 connected to each of the water purification chambers 150 through the corresponding communication hole 143 formed in each of the partitions 141.

The communication holes 143 formed in the neighboring partitions 141 deviate from each other. For example, a communication hole 143a formed in a partition 141a is disposed to deviate from communication holes 143b and 143c formed in neighboring partitions 141b and 141c (See FIG. 7B). In other words, the communication holes 143 are formed in the respective partitions 141 such that an extension line L1 linking the communication holes 143a and 143b and an extension line L2 linking the communication holes 143a and 143c are at an angle to a longitudinal extension line L3 of the transparent tube 120. As shown in FIG. 4, the communication holes 143 of the neighboring partitions 141 may be diagonally opposite to each other about the transparent tube 120. In this case, water, having passed through the communication hole 143 of one of the partitions 141, flows along the outer circumference of the transparent tube 120 and then passes through the communication hole 143 of the neighboring partition 141. Consequently, dwell time of water increases in proportion to flow of the water along the outer circumference of the transparent tube 120, thereby improving germicidal efficiency.

The flow channel defining member 140 is coupled to the outer circumference of the transparent tube 120 and the inner circumference of the housing 110 in a watertight state to prevent water from leaking between the flow channel defining member 140 and the transparent tube 120 or between the flow channel defining member 140 and housing 110. Since the partitions 141 of the flow channel defining member 140 are perpendicular to the outer circumference of the transparent tube 120 and the inner circumference of the housing 110 in this embodiment as compared with a continuous spiral vane, the flow channel defining member 140 is easily coupled to the outer circumference of the transparent tube 120 and the inner circumference of the housing 110 in a watertight state.

Also, the water purification unit 100 further includes a tab 160 coupled to the outlet port 112 of the housing 110 to allow water having passed through the housing 110 to pass therethrough.

As shown in FIGS. 5 and 6, the tab 160 is formed in the shape of a cylinder. The tab 160 includes a first hole 161 provided at one side thereof, a second hole 162 provided at the other side thereof, and a through-channel 164 defined therein to interconnect the first hole 161 and the second hole 162. The cylinder is only illustrative, and the shape of the tab 160 is not restricted.

The first hole 161 is coupled to the outlet port 112 of the housing 110 such that water having passed through the housing 110 is introduced into the tab 160 through the first hole 161. The water, introduced through the first hole 161, passes through the through-channel 164 and is then discharged out of the tab 160 through the second hole 162 such that the water is supplied to a container or a continuous water supply pipe.

When the operation of the water purification unit 100 is stopped, a low pressure state, such as a vacuum state, is created in the housing 110, with the result that a small amount of water may remain in the through-channel 164 of the tab 160. This is the same principle as by which water drops form at the end of a faucet after the faucet is turned off. When water remains in the through-channel 164, the water remaining in the through-channel 164 may dribble, while the water dispenser 60 is not operated, contaminating the surroundings of the water dispenser 60. Also, ultraviolet rays emitted from the germicidal lamp 130 of the water purification unit 100 do not easily reach water remaining in the through-channel 164, with the result that the water remaining in the through-channel 164 may be contaminated again.

In this embodiment, the tab 160 further includes a plurality of third holes 163 through which atmospheric pressure is applied to the through-channel 164 of the tab 160 to prevent water from remaining in the through-channel 164. The third holes 163 are arranged radially about the first hole 161 coupled to the outlet port 112 of the housing 110. Consequently, atmospheric pressure is applied to water passing through the tab 160, with the result that water is prevented from remaining in the through-channel 164 of the tab 160. The shape, arrangement, and number of the third holes 163 in this embodiment are illustrative and may be modified in various ways.

Also, the tab 160 further includes an isolator 165 provided at the through-channel 164 to prevent ultraviolet rays emitted from the germicidal lamp 130 from being discharged outside through the through-channel 164. The isolator 165 has a first wall 165a and a second wall 165b. Ultraviolet rays not isolated by the first wall 165a are isolated by the second wall 165b. The first wall 165a and the second wall 165b may be formed in various shapes as long as the first wall 165a and the second wall 165b protrude toward the through-channel 164. For example, the first wall 165a and the second wall 165b may be perpendicular to or at an angle to a flow direction f of water. In this embodiment, the first wall 165a and the second wall 165b are at a predetermined angle to the flow direction f of water in consideration of flow resistance of water. The first wall 165a and the second wall 165b may be curved. Also, the isolator 165 may have three or more walls, and the shape and number of the walls are not restricted.

As shown in FIGS. 7A and 7B, water, introduced into the housing 110 of the water purification unit 100 through the inlet port 111, sequentially passes through the water purification chambers 150 arranged in the longitudinal direction of the transparent tube 120. While sequentially passing through the water purification chambers 150, the water is exposed to ultraviolet rays emitted from the germicidal lamp 130 disposed in the transparent tube 120, with the result that various germs are removed from the water. At this time, the water, having passed through one of the communication holes 143, flows along the outer circumference of the transparent tube 120 to reach the next communication hole 143, since the communication holes 143 formed in the neighboring partitions 141 deviate from each other, with the result that dwell time of water in the housing 110 is increased. After passing through all the water purification chambers 150, the water flows out of the housing 110 through the outlet port 112 and is then discharged through the tab 160.

In the water purification unit 100 according to this embodiment, as described above, dwell time of water in the housing 110 where a germicidal process is carried out by ultraviolet rays is increased by the flow channel defining member 140, thereby improving germicidal efficiency of the water purification unit 100. The results of performance tests on the conventional water purification unit having the spiral tube shown in FIG. 1B and the water purification unit having the flow channel defining chamber according to this embodiment reveal the increase of germicidal efficiency. Specifically, the water purification unit of FIG. 1B has a germicidal efficiency of about 99.94% when using an ultraviolet germicidal lamp of 15 W, and the water purification unit according to this embodiment has a germicidal efficiency of about 99.98% when using an ultraviolet germicidal lamp of 5 W. That is, power consumption is reduced by 30%, and germicidal efficiency is improved. For pressure loss generated while water passes through the housing, the water purification unit of FIG. 1B has a pressure loss of 236 mmAq, and the water purification unit according to this embodiment has a pressure loss of 214 mmAq. That is, the flow resistance generated in the water purification unit according to this embodiment while water passes through the water purification unit is lower than in the conventional water purification unit.

Also, in the water purification unit 100 according to this embodiment, the partitions 141 partitioning the water purification chambers 150 are mounted perpendicularly to the outer circumference of the transparent tube 120, with the result that there is no dead zone where ultraviolet rays are intercepted by the partitions 141, thereby further improving germicidal efficiency of the water purification unit.

Also, in the water purification unit 100 according to this embodiment, the partitions 141 of the flow channel defining member 140 are parallel to one another, with the result that mass production of flow channel defining members by injection molding is easily achieved. The flow channel defining member 140 may be separately produced, and the partitions 141 may be mounted to the outer circumference of the transparent tube 120 or the inner circumference of the housing 110. Alternatively, the partitions 141 may be integrally formed with the transparent tube 120 or the housing 110. In the water purification unit according to this embodiment, therefore, the manufacture of the flow channel defining member 140 is easily achieved, with the result that manufacturing costs are reduced and a manufacturing process is simplified, thereby achieving improved productivity.

Also, in the water purification unit 100 according to this embodiment, atmospheric pressure is applied to the through-channel 164 defined in the tab 160, with the result that water is prevented from remaining in the tab 160. Consequently, water is prevented from dribbling from the tab 160, while the water dispenser 60 is not operated, and therefore, the surroundings of the water dispenser 60 are prevented from being contaminated. Also, water remaining in the tab 160 is prevented from being re-contaminated.

Also, in the water purification unit 100 according to this embodiment, ultraviolet rays are prevented from being discharged outside through the through-channel 164 of the tab 160, with the result that the body of a user is prevented from being exposed to the ultraviolet rays.

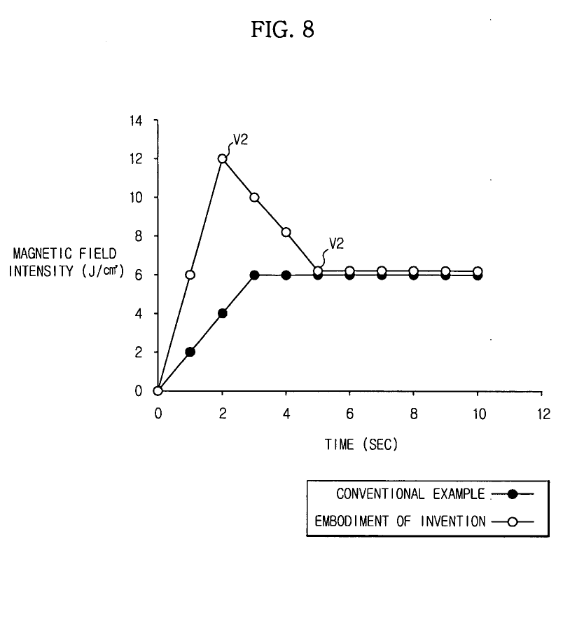

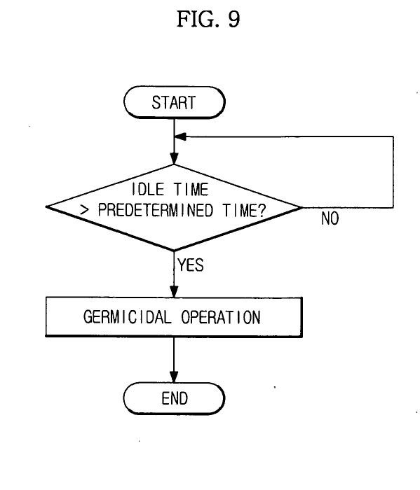

FIG. 8 is a graph illustrating time-based intensity change of ultraviolet rays emitted from a germicidal lamp according to an embodiment, and FIG. 9 is a flow chart illustrating the operation of a water purification unit according to an embodiment in an idle state.

As shown in FIG. 8, the germicidal lamp of the water purification unit according to this embodiment may be operated in two stages. In a first stage, the intensity of ultraviolet rays emitted from the germicidal lamp rises to a peak value V1 for a predetermined period of time and then lowers to a predetermined value, i.e., a normal value V2. In a second stage, the intensity of ultraviolet rays emitted from the germicidal lamp is uniformly maintained at the normal value V2. The peak value V1 may be two or more times the normal value V2.

Consequently, warm-up time of the water purification unit 100 is reduced. Specifically, when a user inputs a discharge command, the water purification unit 100 operates the germicidal lamp 130 for a predetermined period of time and discharges water through the water dispenser 60. This is because water in the water purification unit 100 may be contaminated again while the water purification unit 100 is not operated. In the water purification unit 100 according to this embodiment, the intensity of ultraviolet rays emitted from the germicidal lamp 130 of the water purification unit 100 rises to about two or more times the normal intensity of ultraviolet rays in the early operation stage of the water purification unit 100, thereby reducing warm-up time of the water purification unit 100.

Also, the water dispenser 60 may further include a proximity sensor 62 to sense the movement of an object to the water dispenser 60. When the movement of the object to the water dispenser 60 is sensed by the proximity sensor 62, the germicidal lamp 130 of the water purification unit 100 may start to operate. As a result, user wait time during warm-up of the water purification unit 100 may be reduced. That is, when the user moves a container to the water dispenser 60 to take water out, the movement of the container to the water dispenser 60 is sensed by the proximity sensor 62, and therefore, warm-up of the water purification unit 100 may start. Subsequently, when the user pushes the lever of the water dispenser 60, water may be taken out as quickly as the warm-up starts.

Also, in the refrigerator according to this embodiment, as shown in FIG. 9, the germicidal lamp 130 may be periodically operated when the flow of water through the water purification unit 100 is stopped for a predetermined period of time. As a result, water remaining in the water purification unit 100 is kept clear, and warm-up time of the water purification unit 100 is reduced.

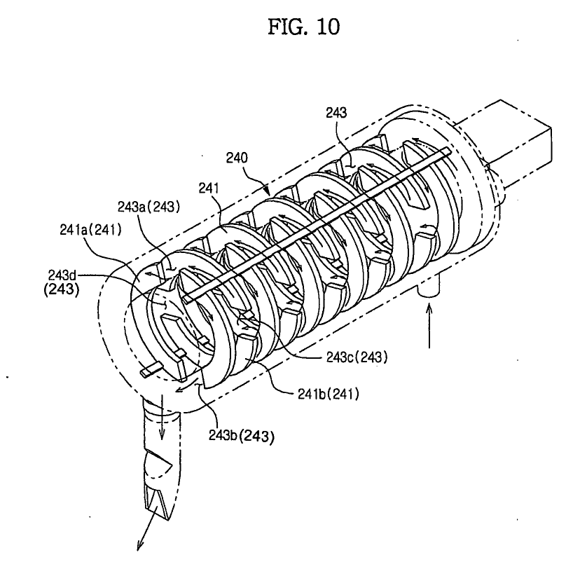

FIG. 10 is a perspective view, corresponding to FIG. 7, illustrating a flow channel defining member 240 according to another embodiment. Components of this embodiment identical to those of the previous embodiment are denoted by the same reference numerals, and a description thereof will not be given.

In this embodiment, as shown in FIG. 10, each partition 241 of the flow channel defining member 240 has two communication holes 243. Neighboring communication holes have a phase difference of 90 degrees. For example, a partition 241a is provided at regions corresponding to 0 and 180 degrees with communication holes 243a and 243b, respectively. Another partition 241b next to the partition 241a is provided at regions corresponding to 90 and 270 degrees with communication holes 243c and 243d, respectively. However, the position and number of the communication holes formed in the partitions of the flow channel defining member are not restricted.

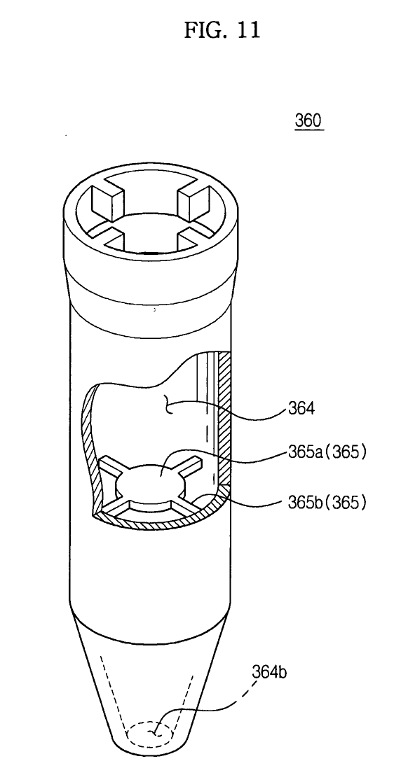

FIG. 11 is a partially cutaway perspective view illustrating a tab 360 according to another embodiment.

In this embodiment, an isolator 365 of the tab 360 includes a body 365a to intercept ultraviolet rays and a support 365b to support the body 365a at the inner circumference of a through-channel 364. To effectively intercept ultraviolet rays, the body 365a of the isolator 365 may have a greater sectional area than an outlet port 364b of the through-channel 364. The isolator 365 may be modified in various ways.

Above, the water purification unit is described as being applied to the refrigerator; however, the water purification unit may be provided in a water purification device, a normal water pipe, and various other devices and members.

As is apparent from the above description, a refrigerator according to an embodiment has reduced flow resistance, improved productivity, and improved germicidal efficiency.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A refrigerator comprising:
a refrigerator body having at least one storage chamber;
a door to open and close the storage chamber;
a water dispenser provided in the door; and
a water purification unit to purify water to be supplied to the water dispenser, wherein
the water purification unit comprises a housing having an inlet port and an outlet port, a transparent tube provided in the housing, a germicidal lamp provided in the transparent tube to emit ultraviolet rays, and a flow channel defining member provided between the housing and the transparent tube, and
the flow channel defining member comprises a plurality of partitions perpendicular to an outer circumference of the transparent tube, each of the partitions having at least one communication hole.

2. The refrigerator according to claim 1, wherein the partitions are arranged such that communication holes of neighboring ones of the partitions deviate from each other.

3. The refrigerator according to claim 2, wherein the communication holes of the neighboring partitions are diagonally opposite to each other about the transparent tube.

4. The refrigerator according to claim 1, wherein the flow channel defining member is coupled to the outer circumference of the transparent tube and an inner circumference of the housing in a watertight state.

5. The refrigerator according to claim 1, wherein the water purification unit is provided in the door.

6. The refrigerator according to claim 5, wherein the door comprises an inner liner and an outer liner and the water purification unit is provided between the inner liner and the outer liner of the door.

7. The refrigerator according to claim 1, wherein
the water purification unit further comprises a tab coupled to the outlet port of the housing to allow water having passed through the housing to pass therethrough, and
atmospheric pressure is applied to the water passing through the tab.

8. The refrigerator according to claim 7, wherein the tab comprises a first hole to allow the water having passed through the housing to be introduced into the tab therethrough, a second hole to allow the water introduced through the first hole to be discharged out of the tab therethrough, a through-channel connected between the first hole and the second hole, and a third hole to allow atmospheric pressure to be applied to the through-channel therethrough.

9. The refrigerator according to claim 8, further comprising a plurality of the third holes arranged radially about the first hole.

10. The refrigerator according to claim 1, wherein
the water purification unit further comprises a tab coupled to the outlet port of the housing, the tab having a through-channel to allow water having passed through the housing to pass therethrough, and
the tab comprises an isolator provided at the through-channel to prevent the ultraviolet rays emitted from the germicidal lamp from being discharged outside through the through-channel.

11. The refrigerator according to claim 10, wherein the isolator comprises at least one wall.

12. The refrigerator according to claim 10, wherein the isolator comprises a body to intercept ultraviolet rays and a support to support the body at an inner circumference of the through-channel.

13. The refrigerator according to claim 12, wherein the body of the isolator has a greater sectional area than an outlet port of the through-channel.

14. The refrigerator according to claim 1, wherein the ultraviolet rays emitted from the germicidal lamp have an intensity rising for a predetermined period of time after the start of the operation of the germicidal lamp, lowering to a predetermined value after the predetermined period of time, and being maintained at the predetermined value.

15. The refrigerator according to claim 1, wherein the germicidal lamp is periodically operated when the flow of water through the water purification unit is stopped for a predetermined period of time.

16. The refrigerator according to claim 1, wherein
the water dispenser comprises a proximity sensor to sense movement of an object to the water dispenser, and
the germicidal lamp of the water purification unit starts to operate when the movement of the object to the water dispenser is sensed by the proximity sensor.

17. A water purification device comprising a water purification unit, wherein
the water purification unit comprises a housing having an inlet port and an outlet port, a transparent tube provided in the housing, a germicidal lamp provided in the transparent tube to emit ultraviolet rays, and a plurality of water purification chambers provided successively in a longitudinal direction of the transparent tube while surrounding the transparent tube, and
the water purification unit further comprises a plurality of communication holes provided in the longitudinal direction of the transparent tube to achieve communication between neighboring ones of the water purification chambers, whereby
water, introduced into the housing through the inlet port, sequentially passes through the successive water purification chambers, and is discharged out of the housing through the outlet port.

18. The water purification device according to claim 17, wherein the communication holes are provided such that an extension line linking neighboring ones of the communication holes is at an angle to a longitudinal extension line of the transparent tube.

19. A refrigerator comprising:
a refrigerator body having at least one storage chamber;
a door to open and close the storage chamber;
a water dispenser provided in the door; and
a water purification unit to purify water to be supplied to the water dispenser, wherein
the water purification unit comprises a housing having an inlet port and an outlet port, a water purification member provided in the housing, and a tab coupled to the outlet port of the housing to allow water having passed through the housing to pass therethrough, and
atmospheric pressure is applied to the water passing through the tab such that the water is easily taken out through the tab.

20. The refrigerator according to claim 19, wherein the tab comprises a first hole to allow water having passed through the housing to be introduced into the tab therethrough, a second hole to allow the water introduced through the first hole to be discharged out of the tab therethrough, a through-channel connected between the first hole and the second hole, and a third hole to allow atmospheric pressure to be applied to the through-channel therethrough.

21. The refrigerator according to claim 20, wherein the third hole comprises a plurality of third holes arranged radially about the first hole.

22. The refrigerator according to claim 19, wherein the water purification member comprises a germicidal lamp to emit ultraviolet rays.

23. A refrigerator comprising:
a refrigerator body having at least one storage chamber;
a door to open and close the storage chamber;
a water dispenser provided in the door; and
a water purification unit to purify water to be supplied to the water dispenser, wherein
the water purification unit comprises a housing having an inlet port and an outlet port, a germicidal lamp provided in the housing to emit ultraviolet rays to water passing through the housing, and a tab coupled to the outlet port of the housing to allow the water having passed through the housing to pass therethrough, and
the tab comprises a through-channel to allow water to pass therethrough and an isolator provided at the through-channel to prevent the ultraviolet rays emitted from the germicidal lamp from being discharged outside through the through-channel.

24. The refrigerator according to claim 23, wherein the isolator comprises at least one wall.

25. The refrigerator according to claim 23, wherein the isolator comprises a body to intercept ultraviolet rays and a support to support the body at an inner circumference of the through-channel.

26. The refrigerator according to claim 25, wherein the body of the isolator has a greater sectional area than an outlet port of the through-channel.
